(19) United States
(12) Patent Application Publication
(10) Pub. No.: US 2017/0206233 A1
(43) Pub. Date: Jul. 20, 2017

(54) CONTENT SEARCH FOR VERSIONED DATABASE DATA

(71) Applicant: Datos IO Inc., San Jose, CA (US)

(72) Inventors: Maohua Lu, Fremont, CA (US); Pin Zhou, San Jose, CA (US); Prasenjit Sarkar, Los Gatos, CA (US)

(21) Appl. No.: 15/409,777

(22) Filed: Jan. 19, 2017

Related U.S. Application Data
(60) Provisional application No. 62/280,470, filed on Jan. 19, 2016.

(51) Int. Cl. G06F 17/30

(52) U.S. Cl. CPC G06F 17/30353; G06F 17/30321; G06F 17/30356; G06F 17/30551; G06F 17/30554

(57) ABSTRACT

Embodiments disclosed herein provide systems, methods, and computer readable media for searching content in versioned database data. In a particular embodiment, a method provides obtaining a first data version of database data and indexing the first data version to create a first index. The first index includes a time indicator corresponding to creation of the first data version. The method further provides incorporating the first index into a searchable index of one or more additional data versions. The searchable index includes one or more time indicators that each correspond to a respective one of the one or more additional data versions. Additionally, the method provides receiving a search query including at least one of an event, time, and/or time range parameter and returning information from the searchable index that satisfies the time parameter.

### RELATED APPLICATIONS

This application is related to and claims priority to U.S. Provisional Patent Application 62/280,470, titled “CONTENT SEARCH FOR VERSIONED NOSQL DATA,” filed Jan. 19, 2016, and which is hereby incorporated by reference in its entirety.

### TECHNICAL BACKGROUND

A NoSQL or SQL database, like many other types of databases, can be duplicated (for backup purposes or otherwise) by generating versions of the database at various times. Each version of the database may be generated by capturing a snapshot of the database. The snapshot includes all data in the database as the data stood at the time the snapshot was generated. In some cases, a particular snapshot may only include data that has been changed since a previous snapshot. Regardless, maintaining multiple versions of a database allows the changes that occur in that database to be cataloged for later reference. However, in many cases, the amount of data maintained for database versions can be very large and, thereby, hard to sort through.

### OVERVIEW

Embodiments disclosed herein provide systems, methods, and computer readable media for searching content in versioned database data. In a particular embodiment, a method provides obtaining a first data version of database data and indexing the first data version to create a first index. The first index includes a time indicator corresponding to creation of the first data version. The method further provides incorporating the first index into a searchable index of one or more additional data versions. The searchable index includes one or more time indicators that each correspond to a respective one of the one or more additional data versions.

In some embodiments, the method provides receiving a search query including at least one of an event, time, and/or time range parameter and returning information from the searchable index that satisfies the time parameter.

In some embodiments, indexing the first data version comprises indexing data items of the first data version that satisfy a quorum requirement across nodes of a database from which the database data is obtained.

In some embodiments, indexing the first data version comprises converting data of the first data version to first user searchable information and indexing the first user searchable information. In those embodiments, the first user searchable information may comprise information in a data field of each data item in the first data version and the user searchable information may be associated with the time indicator.

In some embodiments, the method provides deleting portions of the searchable index that correspond to data versions older than a threshold age. In those embodiments the method may further provide deleting the data versions older than the threshold age.

In some embodiments, the method provides storing the first data version to a version storage volume.

In some embodiments, the first data version includes data items from at least two different types of NoSQL databases.

In another embodiment, a system is provided having one or more computer readable storage media and a processing system operatively coupled with the one or more computer readable storage media. Program instructions stored on the one or more computer readable storage media, when read and executed by the processing system, direct the processing system to obtain a first data version of database data and index the first data version to create a first index. The first index includes a time indicator corresponding to creation of the first data version. The program instructions further direct the processing system to incorporate the first index into a searchable index of one or more additional data versions. The searchable index includes one or more time indicators that each correspond to a respective one of the one or more additional data versions.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment for searching content in versioned database data.

FIG. 2 illustrates a method of operating the computing environment to search content in versioned database data.

FIG. 3 illustrates an operational scenario of the computing environment to search content in versioned database data.

FIG. 4 illustrates another computing environment for searching content in versioned database data.

FIG. 5 illustrates an operational scenario of the other computing environment to search content in versioned database data.

FIG. 6 illustrates an index system for searching content in versioned database data.

### DETAILED DESCRIPTION

When a version of a database is created, the data content in the version is stored for later reference. That later reference may be to restore the database to a state when the version was created. For example, the database may become corrupt and, therefore, the database is restored to a prior state in which the database was not corrupt. Rather than simply keeping past versions of a database in storage for the possibility of restoring the database to a state represented by one or more of the versions, information represented by the data maintained in the versions may still be useful. For example, a user may be interested in information that existed in the database in the past but no longer exists in the database.

Accordingly, this disclosure provides a method to index versioned user data for a data store so that users can search for a particular piece of user data throughout the user data's life cycle. Three steps are involved in the method. First, when versioned data is being replayed from the storage backend, user data is extracted and indexed into a searchable index in an asynchronous fashion. Second, during the indexing, the dynamic nature of a data store is taken into consideration to cater for the new features of the data store. Third, during the indexing, the lifecycle events of user data, including creation, update and delete, are taken into consideration to serve subsequent life-cycle-related queries.

The above method allows for 1) real time processing when user data is versioned, 2) the capability to process the data store, and 3) lifecycle management including creation of, updates to, and deletions of user data. Advantageously, the method provides the ability to process and organize searchable index in real time for versioned data, regardless of whether the versioned data is for a traditional data store, a SQL data store, or a NoSQL data store, although the disclosure below will focus on the NoSQL data store.

There are 2 challenges in processing a searchable index in real time, 1) processing data on the fly without storing the data first, and 2) minimize the performance overhead to the data versioning process itself. The method described herein address both of these two challenges. To address the first challenge, the method divides the versioning into two stages, namely, the uploading phase and replay phase. In the uploading phase, the to-be-versioned data are transferred to the backend storage as a byte stream without interpreting the data content. In the replay phase, the data stored in the backend are read and the content is interpreted to extract the per-record information to achieve database-level consistency. The per-record information is the same as that was entered by the data store user. The method provides the ability to leverage the replay phase to index the extracted per-record information. In this way, the indexing of the data can be piggy-backed with the read of data in the replay phase. The method is unique for consistent versioning as replay is only needed to achieve database-level consistency for consistent versioning. Given that the proposed versioning algorithm aims to achieve consistent versioning, the proposed method to process data on the fly is also unique in the art.

To address the second challenge, the method takes steps to minimize the performance overhead. The performance overhead of processing comes from three aspects, CPU overhead due to data indexing, space overhead due to the persistence of indexed data, and the memory overhead due to the in-memory data structure when indexing data. First, the indexing process is separate from the replay process, where the indexing process shares data with the replay process through queuing. In this fashion, the CPU overhead can be limited to a separate CPU asynchronous with the replay process. Second, only the data field is indexed to take advantage of the large degree of repetition for user data. As the index data is compressed and the high repetition of data helps the compression, the space usage of the index can be reduced. Third, the memory used for both indexing and sharing between the replay and indexing thread are flushed to storage periodically to alleviate the memory pressure. With these techniques combined together, the performance overhead of processing and indexing data can be significantly reduced.

Another challenge that is overcome by the method herein is the challenge of managing the versioning history of data. There are two specific challenges, 1) each field data can be created, updated and deleted at any given time, 2) for a NoSQL data store, each event (create, update, or delete) could take time to propagate to all nodes. The versioned data therefore needs to understand the semantics of quorum to update the event at the right time. To address the first challenge, when the event occurs, the event is explicit and is indexed with the key <field_value,versioning_timestamp> and the event itself as part of the data. A secondary index includes the key <field_value> and (versioning_timestamp,event) as part of the data. At the query time, when only <field_value> is used to query data, the method queries the secondary index and constructs the full life cycle of the data with their corresponding events. To address the second challenge, the method leverages the quorum algorithm and hooks into the quorum processing to only emit the event when the corresponding data reaches the quorum.

Moreover, the method also provides the ability to index a NoSQL data store where the schema is not fixed and can be dynamic. Two more challenges arise for data indexing when the schema is not fixed and dynamic. First, the position of indexed data needs to be at byte level as the per-record size is not fixed. Second, different versions of the same data (e.g., table) can have different schemas. For this reason, not only the data needs to be versioned, but the schema also needs to be versioned. To address these challenges, the method takes two steps. First, instead of having one-level mapping where the data points to the exact location, the method provides 2-level mapping. Among the 2-level mappings, the first level maps the field to the container region, whereas the second level maps the field to the corresponding offset within the container region. The first level map is kept in memory while the second level persists on storage. The second level mapping is only loaded into memory when needed. Second, the method leverages the schema that is already stored in the versioning flow. When indexing the data, the versioning timestamp is used as part of the primary key of the index. Essentially, the index primary key is <field_value,versioning_timestamp>. With these two techniques, the method fully addresses the challenges introduced by the dynamic nature of NoSQL data store.

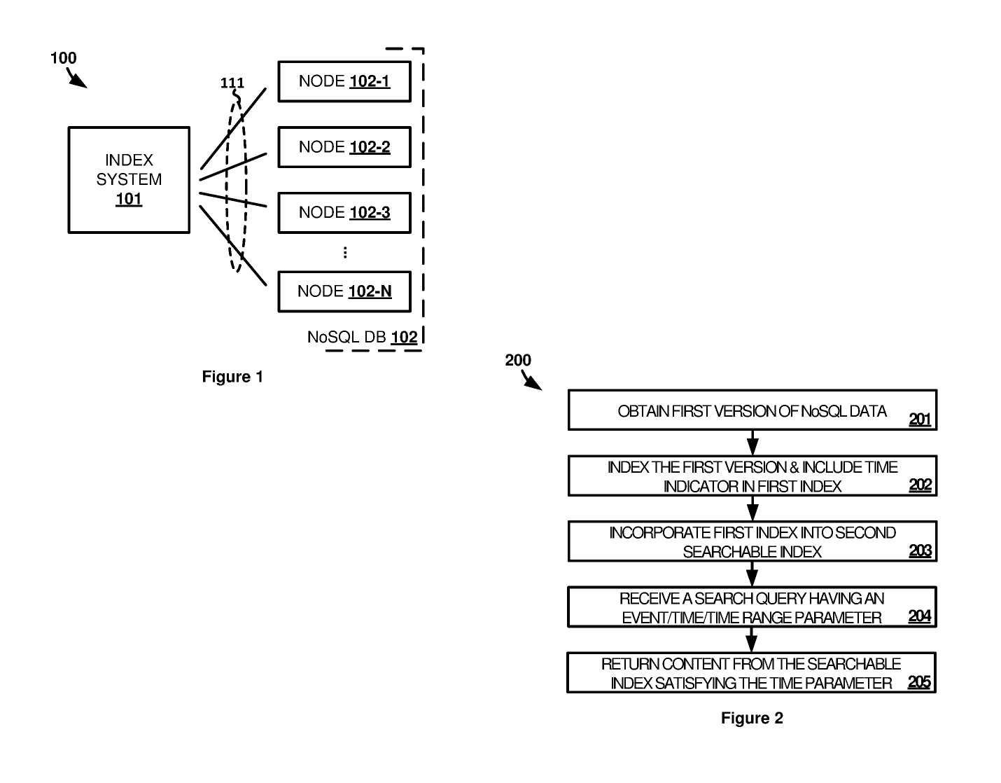

FIG. 1 illustrates computing environment 100 in an example scenario for searching versioned database data. Computing environment 100 includes index system 101 and NoSQL database 102. NoSQL database 102 is made up of nodes 102-1-102-N. Index system 101 and NoSQL database 102 communicate over communication links 111.

In operation, NoSQL database 102 includes multiple nodes. However, NoSQL database 102 may include any number of nodes, including a single node. NoSQL database 102 may include a single database type or may include multiple database types, such as Cassandra or Mongo Likewise, data may be duplicated across different nodes of NoSQL database 102 and/or nodes may include different data. Regardless of the data type in NoSQL database 102, index system 101 indexes versions of the data such that the information in the versions can be searched. More specifically, index system 101 indexes the data and includes a time indicator for the data which indicates when the data version was created. The time indicator allows a search to provide results based on time, rather than simply the information searched for. It should also be understood that, while this embodiment focuses on a NoSQL database, the embodiment may be applied to other types of databases, such as a SQL database.

FIG. 2 illustrates method 200 of computing environment 100 to search versioned database data. Method 200 provides index system 101 obtaining a first data version of NoSQL data from NoSQL database 102 (201). The first data version may be created by index system 101 or may be created by another system and transferred to index system 101. For example, in some cases, computing environment 100 may include a separate versioning system to generate versions of NoSQL database 102. The first data version may include data from a single node of NoSQL database 102 or multiple nodes of NoSQL database 102. Likewise, data versions may be created periodically, upon user instruction, upon a trigger event (e.g. a data change), or on some other type of schedule—including combinations thereof.

Method 200 further provides index system 101 indexing the first data version to create a first index (202). The method used to index the data in the first data version may be any type of data indexing that can be used for searching the data. In some cases, depending on the structure of the first data version, the data in the first data version may need to be converted to user-understandable information. For example, if an element of the first data version corresponds to a person's name but was merely captured as non-descript binary in the first data version, then the binary may need to be interpreted to determine that the person's name is being represented. Otherwise, the person's name would not be known and would not be searchable. Additionally, the first index includes a time indicator corresponding to creation of the first data version. For example, the time indicator may indicate a time when the first data version was created or a time when the first data version was received by index system 101. It should be understood that content items that are unchanged from a previous version and still in database 102 are still considered to be included in the first data version.

Method 200 then provides index system 101 incorporating the first index into a searchable index of one or more additional data versions (203). The searchable index may have been generated through previous iterations of method steps 201-203 performed on each of the additional data volumes. That is, whenever a data version is created for NoSQL database 102, that data version is indexed and incorporated into the already existing searchable index. Accordingly, index system 101 is able to update the searchable index each time a new data version is created by simply indexing the new data version and incorporating that index into the existing searchable index. Updating the searchable index in this way allows the first data version to be searched along with older data versions in a shorter amount of time relative to re-indexing all data versions each time a new data version is generated.

Moreover, like the time indicator of the first data version, the searchable index includes time indicators that each correspond to each of the additional data versions. For example, any information included in the searchable index from a data version generated to months prior to the first data version will be indexed along with a time indicator corresponding to the data version from which that information was indexed. The time indicator for indexed information allows search queries to include a time parameter and allows information returned by the search queries to reference time as well.

The searchable index can be used to search at any time and as soon as first data version (or any data version not already included therein) is incorporated into the searchable index, information in the first data version can be included in search results. As such, method 200 further provides index system 101 receiving a search query including at least one of an event, time, and/or time range parameter (204). The search query may be for any type of information that may be included in a NoSQL database—including combinations thereof. The search query may be received from a user through user input or from another system. The time and time range parameters may indicate a date, time of day, time period(s), or any other way of designating a time or time frame. In some cases, a lack of an explicit time parameter in the search query implies that all times within the searchable index should be considered.

Method 200 then provides index system 101 returning information from the searchable index that satisfies the time parameter (205). The returned information may include content items that fall within the time parameter given in the search request and/or the returned content items may indicate time information associated with each returned content item. For example, the time information for a content item may indicate the times of versions in which the content item was included. For instance, a particular content item may have first been captured in a version from five years ago and was last included in a version from two years ago. Likewise, the search query, like a forensic query, may return an indication of the first version in which the returned information is contained. Additionally, it should be understood that, since the searchable index does not include the actual data from stored versions (which are stored separately on the same or a different data store), the returned information from the searchable index may include pointers to the stored version data or may include the stored stored version data after retrieval from the version data store.

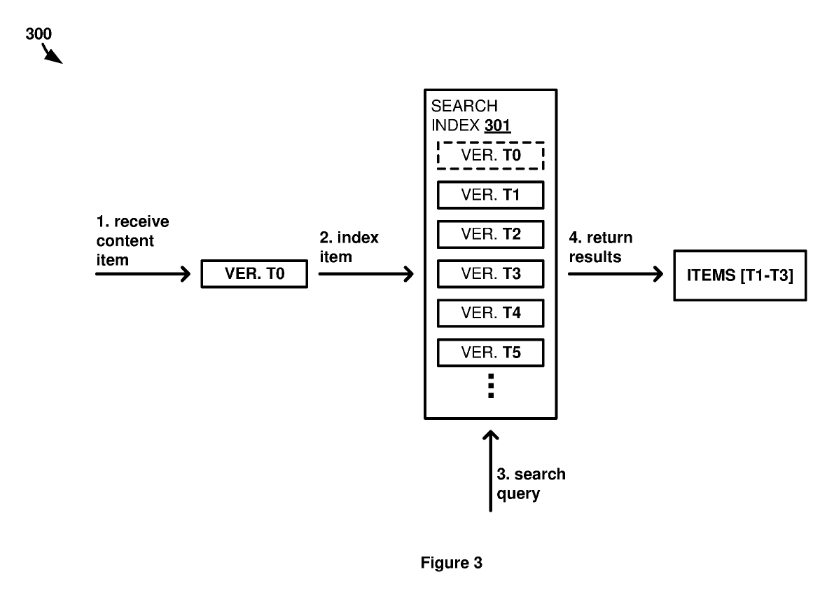

FIG. 3 illustrates operational scenario 300 of computing environment 100 to search content in versioned database data. At step 1, content items are obtained by index system 101 as part of a newly created data version from NoSQL database 102. This new version is labeled version TO since it is the most recent data version. The content items in version T0 are indexed by index system 101 and included in searchable index 301 at step 2. As shown, searchable index 301 also includes indexes of content items in prior captured versions from NoSQL database 102. Each prior version index is labeled T1, T2, T3, etc. with higher numbers corresponding to older data versions. It should be understood that, while the index of the content items is shown in sequential version blocks, the index of content items is structured in accordance with whatever indexing mechanism was used to generate searchable index 301. Content items from the previous data versions may have been indexed and incorporated into searchable index 301 by index system 101 in the same was as the content items of version T0. Searchable index 301 maintains the time information indicating substantially when each data version was created as a component of each indexed content item from each data version.

In some cases, only a certain amount of versions may be maintained. For example, versions older than a certain age (e.g. x number of years) may be deleted or incorporated into newer versions. In those cases, searchable index 301 may be updated by index system 101 to remove content items no longer in any of the remaining versions or the index of those content items may be updated to indicate that they are no longer retrievable from a data version. Likewise, certain content items may be included in both deleted data versions and data versions that remain stored. In those cases, the version time information may continue to indicate that the content items were included in the deleted versions so that a more complete time record of the content items can be maintained.

Index system 101 further receives a search query at step 3. The search query is for any type of information that may be included in NoSQL database 102. The search query may define a time parameter in which the results should be based (e.g. an inclusive or exclusive time frame) or allow for results to be from any time. Index system 101 then searches searchable index 301 for content items that satisfy the search query and returns an indication of the content items that satisfy the query at step 4. In this example, the content items that are returned were included in versions T1-T3, either because the search query defined a time frame of T1-T3 or because that time period happened to be the time period in which the content items were found. As such, the returned items are indicated as existing in NoSQL database 102 from time T1 to time T3. The search results may be displayed to a user if the search query was entered by a user or may be returned in a message to another computing system if the other computing system provided the search query.

Referring back to FIG. 1, index system 101 comprises a computer system and communication interface. Index system 101 may also include other components such as a router, server, data storage system, and power supply. Index system 101 may reside in a single device or may be distributed across multiple devices. Index system 101 could be an application server(s), a personal workstation, or some other network capable computing system—including combinations thereof. While shown separately, all or portions of index system 101 could be integrated with the components of at least one of nodes 102-1-102-N.

Nodes 102-1-102-N of NoSQL database 102 each comprise one or more data storage systems having one or more non-transitory storage medium, such as a disk drive, flash drive, magnetic tape, data storage circuitry, or some other memory apparatus. The data storage systems may also include other components such as processing circuitry, a network communication interface, a router, server, data storage system, user interface and power supply. The data storage systems may reside in a single device or may be distributed across multiple devices.

Communication links 111 could be internal system busses or use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication links 111 could be direct links or may include intermediate networks, systems, or devices.

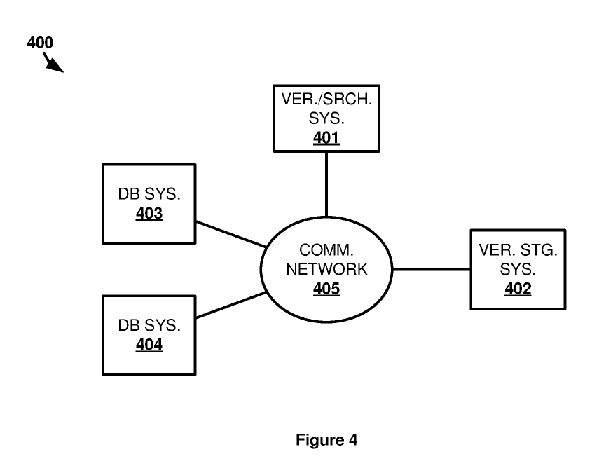

FIG. 4 illustrates computing environment 400 in an example scenario for searching versioned database data. Computing environment 400 includes versioning/searching system 401, version storage system 402, database system 403, database system 404, and communication network 405. Elements 401-404 exchange communications with one another via communication links over communication network 405.

Communication network 405 comprises network elements that provide communications services. Communication network 405 may comprise switches, wireless access nodes, Internet routers, network gateways, application servers, computer systems, communication links, or some other type of communication equipment—including combinations thereof. Communication network 405 may be a single network, such as a local area network, a wide area network, or the Internet, or may be a combination of multiple networks.

In operation, database systems 403 and 404 are NoSQL or SQL databases and versioning/searching system 401 versions database systems 403 and 404. While database systems 403 and 404 may be of the same type, it is possible for database systems 403 and 404 to be different types. For instance, database system 403 may execute a Mongo database while database system 404 may execute a Cassandra database. While both database systems 403 and 404 are illustrated as a single element, it should be understood that each database system may comprise multiple nodes like NoSQL database 102 in computing environment 100.

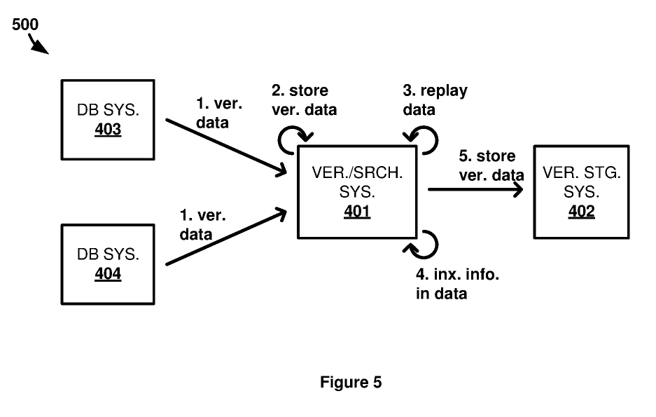

FIG. 5 illustrates operational scenario 500 of computing environment 300 to search content in versioned database data. In scenario 500, versioning/searching system 401 obtains version data at step 1 from database systems 402 and 403. The version data may include all data currently included in the databases on database systems 402 and 403 or may include less than all the data. For example, a database is typically versioned incrementally such that the version data obtained by versioning/searching system 401 only includes data that has changed in since the previous data version was created. Versioning/searching system 401 may initiate the retrieval of the version data periodically, at a scheduled time, or in response to some other trigger for versioning/searching system 401 to generate a data version of the databases of database systems 402 and 493. The received version data is stored in versioning/searching system 401 at step 2 for processing by versioning/searching system 401. Steps 1 and 2 comprise an uploading phase of scenario 500.

Scenario 500 then moves into a replay phase at step 3 where the version data is replayed from storage in versioning/searching system 401 for processing. The replay phase may be used by versioning/searching system 401 to determine whether any of the data in the version data does not meet a predetermined quorum and, therefore, should not be included in the data version. The predetermined quorum indicates a number of nodes in either database system 402 or 403 that need to store particular data for that data to be included in the data version for consistency.

Versioning/searching system 401 in this example takes advantage of the data already being replayed for data consistency to also convert the data into the information therein for indexing. That is, when determining whether data meets the quorum and when later generating the data version, versioning/searching system 401 does need to know what the data represents. However, in order to index the data for searching by a user or otherwise, versioning/searching system 401 needs to determine what information the data represents. For example, certain data may represent a name field item of one of the databases and versioning/searching system 401 determines what the name is in that name field.

After the conversions are performed, as discussed above, versioning/searching system 401 indexes the resulting information at step 4 into a searchable index of all information that will be included in the data verions. The information is indexed in association with a time in which the indexing is being performed, which substantially coincides with the time of creation for the data version in which the information is included. The searchable index further includes the indexing results from previous version data, if any, processed by versioning/searching system 401. Accordingly, when a search query is received by versioning/searching system 401, the searchable index can account both for information and the version time of that information (e.g., when information was included in the databases) when providing results of the search query.

Of course, in addition to indexing the information, versioning/searching system 401 generates the data version and stores the data version at step 5 to version storage system 402. When a search of the searchable index returns data in the data version stored in step 5 (or any previously or subsequently stored data version), the data can be retrieved from version storage system 402. For example, a search query may request information in certain data fields during a specific time frame, which the time associations of the searchable index allow versioning/searching system 401 to provide results from data versions stored on version storage system 402.

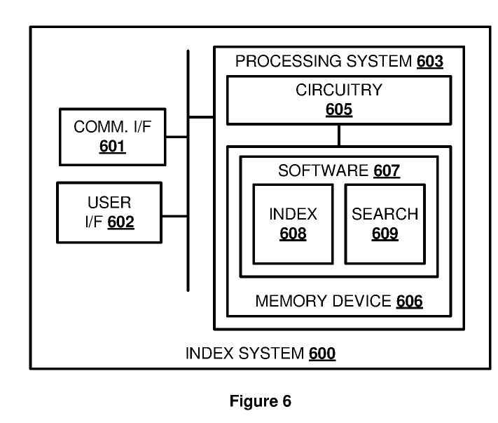

FIG. 6 illustrates index system 600. Index system 600 is an example of index system 101, although system 101 may use alternative configurations. Index system 600 comprises communication interface 601, user interface 602, and processing system 603. Processing system 603 is linked to communication interface 601 and user interface 602. Processing system 603 includes processing circuitry 605 and memory device 606 that stores operating software 607.

Communication interface 601 comprises components that communicate over communication links, such as network cards, ports, RF transceivers, processing circuitry and software, or some other communication devices. Communication interface 601 may be configured to communicate over metallic, wireless, or optical links. Communication interface 601 may be configured to use TDM, IP, Ethernet, optical networking, wireless protocols, communication signaling, or some other communication format—including combinations thereof.

User interface 602 comprises components that interact with a user. User interface 602 may include a keyboard, display screen, mouse, touch pad, or some other user input/output apparatus. User interface 602 may be omitted in some examples.

Processing circuitry 605 comprises microprocessor and other circuitry that retrieves and executes operating software 607 from memory device 606. Memory device 606 comprises a non-transitory storage medium, such as a disk drive, flash drive, data storage circuitry, or some other memory apparatus. Operating software 607 comprises computer programs, firmware, or some other form of machine-readable processing instructions. Operating software 607 includes index module 608 and search module 609. Operating software 607 may further include an operating system, utilities, drivers, network interfaces, applications, or some other type of software. When executed by circuitry 605, operating software 607 directs processing system 603 to operate index system 600 as described herein.

In particular, index module 608 directs processing system 603 to obtain a first data version of database data and index the first data version to create a first index, wherein the first index includes a time indicator corresponding to creation of the first data version. Index module 608 directs processing system 603 to incorporate the first index into a searchable index of one or more additional data versions, wherein the searchable index includes one or more time indicators that each correspond to a respective one of the one or more additional data versions. Search module 609 directs processing system 603 to receive a search query having a time parameter and return information from the second searchable index that satisfies the time parameter.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of searching versioned database data, the method comprising:
obtaining a first data version of database data;
indexing the first data version to create a first index, wherein the first index includes a time indicator corresponding to creation of the first data version; and
incorporating the first index into a searchable index of one or more additional data versions, wherein the searchable index includes one or more time indicators that each correspond to a respective one of the one or more additional data versions.

2. The method of claim 1, further comprising:
receiving a search query including at least one of an event, time, and/or time range parameter; and
returning information from the searchable index that satisfies the query.

3. The method of claim 1, wherein indexing the first data version comprises:
indexing data items of the first data version that satisfy a quorum requirement across nodes of a database from which the database data is obtained.

4. The method of claim 1, wherein indexing the first data version comprises:
converting data of the first data version to first user searchable information; and
indexing the first user searchable information.

5. The method of claim 4, wherein the first user searchable information comprises information in a data field of each data item in the first data version.

6. The method of claim 4, wherein the user searchable information is associated with the time indicator.

7. The method of claim 1, further comprising:
deleting portions of the searchable index that correspond to data versions older than a threshold age.

8. The method of claim 7, further comprising:
deleting the data versions older than the threshold age.

9. The method of claim 1, further comprising:
storing the first data version to a version storage volume.

10. The method of claim 1, wherein the first data version includes data items from at least two different types of NoSQL databases.

11. A system for searching versioned database data, the system comprising:
one or more computer readable storage media;
a processing system operatively coupled with the one or more computer readable storage media; and
program instructions stored on the one or more computer readable storage media that, when read and executed by the processing system, direct the processing system to:
obtain a first data version of database data;
index the first data version to create a first index, wherein the first index includes a time indicator corresponding to creation of the first data version; and
incorporate the first index into a searchable index of one or more additional data versions, wherein the searchable index includes one or more time indicators that each correspond to a respective one of the one or more additional data versions.

12. The system of claim 11, wherein the program instructions further direct the processing system to:
receive a search query including at least one of an event, time, and/or time range parameter; and
return information from the searchable index that satisfies the query.

13. The system of claim 11, wherein to index the first data version, the program instructions direct the processing system to at least:
index data items of the first data version that satisfy a quorum requirement across nodes of a database from which the database data is obtained.

14. The system of claim 11, wherein to index the first data version, the program instructions direct the processing system to at least:
convert data of the first data version to first user searchable information; and
index the first user searchable information.

15. The system of claim 14, wherein the first user searchable information comprises information in a data field of each data item in the first data version.

16. The system of claim 14, wherein the user searchable information is associated with the time indicator.

17. The system of claim 11, wherein the program instructions further direct the processing system to:
delete portions of the searchable index that correspond to data versions older than a threshold age.

18. The system of claim 17, wherein the program instructions further direct the processing system to:
delete the data versions older than the threshold age.

19. The system of claim 11, wherein the program instructions further direct the processing system to:
store the first data version to a version storage volume.

20. The system of claim 11, wherein the first data version includes data items from at least two different types of NoSQL databases.
